(19) United States
(12) Patent Application Publication
(10) Pub. No.: US 2024/0221365 A1
(43) Pub. Date: Jul. 4, 2024

(54) METHODS, APPARATUS FOR OBJECT DETECTION AND STABILIZED RENDERING

(71) Applicant: L'Oreal, Paris (FR)

(72) Inventors: Edmund Phung, Toronto (CA); Zhi Yu, Toronto (CA)

(73) Assignee: L'Oreal, Paris (FR)

(21) Appl. No.: 18/397,999

(22) Filed: Dec. 27, 2023

Related U.S. Application Data
(60) Provisional application No. 63/435,837, filed on Dec. 29, 2022.

(30) Foreign Application Priority Data
Mar. 30, 2023 (FR) 2303057

(51) Int. Cl. G06V 10/774; G06Q 30/0601; G06T 7/246; G06T 7/73; G06T 11/00; G06V 10/82; G06V 40/16

(52) U.S. Cl. CPC G06V 10/774; G06Q 30/0631; G06Q 30/0643; G06T 7/248; G06T 7/74; G06T 11/00; G06V 10/82; G06V 40/171; G06V 40/172; G06T 2207/20081; G06T 2207/20084; G06T 2207/30201

(57) ABSTRACT

There is provided systems, methods and devices for object detection and systems methods and devices for stabilize rendering of effects such as a makeup effect applied to a face image. In an embodiment, a face in a face input image is localized using a face tracker comprising one or more deep neural networks (DNNs) trained to localize facial features; and a training image is produced comprising the face as localized, the training image comprising either an occluded training image where an occluding object is rendered to the face or a non-occluded training image showing the face without the facemask, the training image produced for occluded face DNN training. In an embodiment, rendering of an effect to a current frame of a video stream is responsive to stabilization of a location of detected features in the stream.

### CROSS-REFERENCE

This application claims a domestic benefit of, or otherwise a priority to, U.S. Application No. 63/435,837 filed Dec. 29, 2022 and entitled “Methods, Apparatus for Object Detection and Stabilized Rendering”, the entire contents of which are incorporated herein by reference. This application claims a priority to French Patent application Serial No. FR 2303057 filed on Mar. 30, 2023, the entire contents of which are incorporated herein by reference.

### FIELD OF INVENTION

The present disclosure relates to image processing for example using deep neural networks and more particularly to methods and apparatus for object detection and for stabilized rendering.

### BACKGROUND

Deep learning techniques are useful to process images, including a series of video frames, to localize one or more objects in the images. In an example, the objects are facial features comprising portions of a user's face. Image processing techniques are also useful to render effects in association with such objects such as to augment reality for the user. One example of such an augmented reality is providing a virtual try on (VTO) that simulates the application of a product to an object. Product simulation in the beauty industry includes simulating makeup, hair, and nail effects. Other examples can include iris localization and the simulation of a color change thereto such as by a colored contact lens. These objects and simulations as well as others will be apparent.

In frames of a video, the location of an object in a current frame can be different from its location in an earlier frame as a result of a movement, for example. Localization of a particular object in two or more frames using a deep neural network can lead to unwanted results when effects are applied due to inaccurate localization between frames.

Improved techniques are desired to determine object information from images to facilitate providing augmented realities including VTO experiences.

### SUMMARY

There is provided systems, methods and devices for object detection and systems methods and devices for stabilize rendering of effects such as a makeup effect applied to a face image. In an embodiment, a face in a face input image is localized using a face tracker comprising one or more deep neural networks (DNNs) trained to localize facial features; and a training image is produced comprising the face as localized, the training image comprising either an occluded training image where an occluding object is rendered to the face or a non-occluded training image showing the face without the facemask, the training image produced for occluded face DNN training. In an embodiment, rendering of an effect to a current frame of a video stream is responsive to stabilization of a location of detected features in the stream.

In embodiment, there is provided a computer implemented method comprising executing by one or more processors the steps of: localizing a face in a face input image using a face tracker comprising one or more deep neural networks (DNNs) trained to localize facial features; and producing a training image comprising the face as localized, the training image comprising either an occluded training image where an occluding object is rendered to the face or a non-occluded training image showing the face without the facemask, the training image produced for occluded face DNN training.

In an embodiment there is provided a system comprising: a face tracker engine comprising a deep neural network (DNN) to localize a face in a face input image; and a training image generator to produce a training image comprising the face as localized, the training image comprising either an occluded training image where an occluding object is rendered to the face or a non-occluded training image showing the face without the occluding object, the training image produced for occluded face DNN training.

In an embodiment there is provided a computer implemented method comprising executing by one or more processors the steps of: localizing a facial feature in a current frame of a set of frames of a video stream using a face tracking engine having one or more deep neural networks (DNNs) configured to process the current frame to predict a tracker location of the facial feature; generating a current stabilized location for the facial feature in the current frame, the generating responsive to the tracker location and prior stabilized locations of the facial feature in prior frames of the video stream; and rendering an effect to the current frame associated with the facial feature responsive to the current stabilized location, the effect simulating a product to try on as a component of a virtual try on experience.

In an embodiment there is provided a system comprising: a face tracker engine having computational circuitry configured to localize a facial feature in a current frame of a set of frames of a video stream using one or more deep neural networks (DNNs) configured to process the current frame to predict a tracker location of the facial feature; a stabilizing component having computational circuitry configured to generate a current stabilized location for the facial feature in the current frame, the generating responsive to the tracker location and prior stabilized locations of the facial feature in prior frames of the video stream; and a rendering component having computational circuitry configured to render an effect to the current frame associated with the facial feature responsive to the current stabilized location, the effect simulating a product to try on as a component of a virtual try on experience.

These and other embodiments will be apparent to a person of ordinary skill in the art.

### BRIEF DESCRIPTION OF DRAWINGS

FIG. 1 is a block diagram showing a training pipeline including components to generate synthetic training images, in accordance with an embodiment.

FIGS. 2A, 2B, 2C, 2D and 2E are illustrations of representative images of faces including, respectively, a face image, a cropped face image, two synthetic training images, and a face image with face points in accordance with embodiments.

FIG. 3 is a flowchart of operations such as for a computer implemented method in accordance with an embodiment.

FIG. 4 is an illustration of a computing environment, in accordance with an embodiment, such as for performing a virtual try on.

FIG. 5 is a flowchart of operations such as for a computer implemented method in accordance with an embodiment.

FIG. 6 is an illustration of a computing environment, in accordance with an embodiment, such as for performing a virtual try on.

FIG. 7 is a flowchart of operations such as for a computer implemented method in accordance with an embodiment.

### DETAILED DESCRIPTION

In accordance with embodiments herein, there is described one or more methods, apparatus and techniques for object localization, and object stabilization. Such may be used independently or together. In relation to object localization, there is described methods, apparatus and techniques to generate synthetic data and training a network model using such synthetic data.

In embodiments described herein, the classes of objects, such as for classification or classification and localization, are various facial features. In an embodiment such features comprise a face contour, a nose, an inner mouth, an outer mouth, a left eye, a right eye, a left brown and a right brow. In embodiment, an additional class of objects includes a facemask such as one worn to reduce transmission of airborne particles such as aerosols. A facemask can occlude, in whole or in part, one or more of the facial features in a face image. Examples of occluded facial features, or parts thereof include a nose, an inner mouth, an outer mouth, and a face contour (e.g. portions of a jawline, chin or both).

In embodiments herein, one or more deep neural networks, for example as a component of a face tracker engine, classifies and localizes an input image to detect objects therein and determine respective locations of at least some of the detected objects. In an embodiment, a first deep neural network determines whether a face is present and provides a bounding box, for example, with which to crop the input image to localize the face therein. In an embodiment, a second deep neural network classifies and localizes a plurality of facial features (e.g. each detected objects) in a face image comprising the cropped input image. Localization, in an embodiment of such a network, comprises identifying face points defining general contours for at least some of the detected facial features. In an embodiment, for example, working in parallel and processing the same cropped face image, a further deep neural network classifies whether a facemask in present or not on the cropped face. In an embodiment, localization of the facemask per se is not performed. In an embodiment, the facemask is localized.

In an embodiment, for example, working in parallel and processing the same cropped face image, but instead of classifying, a further deep neural network performs segmentation and provides a segmentation mask showing where a facemask is present or not on the cropped face.

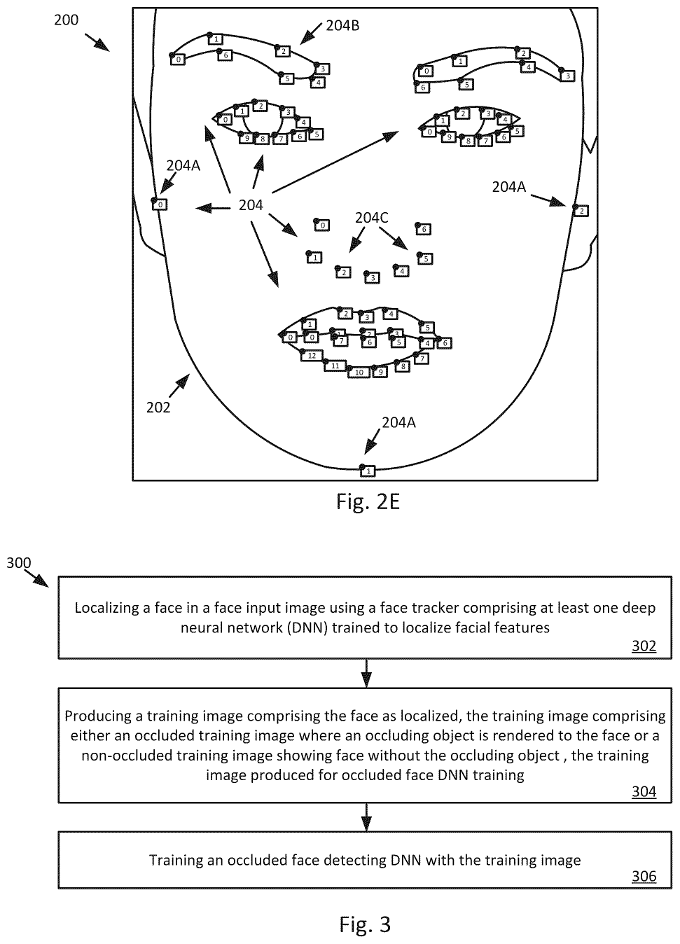

Classification, localization and/or segmentation for facemasks is useful, such as in a makeup virtual try on application. An effect to be tried on can be rendered relative to the classification and/or localization, for example, not rendering where a whole or portion of the face to be rendered is occluded. Facemask classification results could be used to not render lipstick. The rendering can be relative to segmentation such as a segmentation mask for an occluding object. Thus, in an embodiment, a face tracker engine can output any one or more of classification results, localization results and segmentation results for at least some of the objects. The localization results can comprise face points providing contours, relative to a processed image. FIG. 2E described further herein below illustrates face points.

In an embodiment, as noted, rendering operations or a rendering component, as may be applicable to methods and apparatus, render an output image with an effect applied to the face responsive to at least some of the detected objects in the input image. In embodiments, the effect applied is a makeup effect, such as, but not limited to, an effect of an eye, a brow or a lip makeup product. In embodiments, the rendering is a component of a VTO experience for a user. In some examples, an effect is rendered to one or more of the detected objects. An example is the rendering of an eyebrow effect to each eyebrow and another is the rendering of a lip effect to each lip. Typically makeup looks are symmetrically rendered but need not be. In some examples, the effect is rendered to a region adjacent to or otherwise located relative to one or more detected objects. An example is the rendering of an eye makeup effect to each eyelid where each eye region is located usually at least partially between a detected eye and a detected eyebrow pair. Another example is the rendering of blush or other cheek makeup to a check located, for example, relative to the eye and the face contour.

In an embodiment, such as for providing a VTO experience from a “live” stream of video (e.g. a selfie video), each frame (e.g. each image) of the video is processed to detect and localize the objects, and to render at least one effect responsive to a location of the detected objects in accordance with a product or service to be virtually tried on. Thus, the input can comprise a selfie image, which can comprise a selfie video frame.

In embodiments, the respective locations for the at least some detected objects are derived from contours (e.g. face points) generated by the face tracker engine (e.g. one or more deep neural networks thereof). In some embodiments, such as where the input image is a current frame of a series of frames of a video, a stabilizing operation or component, as may be applicable to methods and apparatus, stabilizes the respective locations of the at least some of the detected objects prior to the rendering of the effect. Object stabilizing is further described herein below.

### Object Detection

An example of a deep neural network for object detection is described in Sandler et al., “MobileNetV2: Inverted Residuals and Linear Bottlenecks” (2018), published 13 Jan. 2018, Computer Science, 2018 IEEE/CVF Conference on Computer Vision and Pattern Recognition, the contents of which are incorporated herein by reference in their entirety. A copy of this publication is available at the time of filing at arxiv.org/abs/1801.04381. A deep neural network configured in accordance with this publication is referenced as a MobileNetV2 deep neural network herein. MobilenetV2 deep neural networks are themselves derived from an earlier single shot detector, an example of a deep neural network for detecting objects in images as is described in Liu, Wei, et al. “Ssd: Single shot multibox detector.” In European conference on computer vision, pp. 21-37. Springer, Cham, 2016. An earlier version was published, Dec. 8, 2015 at arxiv.org, available at the time of filing at arxiv.org/abs/1512.02325.

In accordance with an embodiment herein, one or more deep neural networks are configured such as through training to detect (in an image) facial features including a face wearing a facemask or a face otherwise occluded by an occluding object, where the deep neural network is adapted from a MobilenetV2 deep neural network. In an embodiment, the one or more deep neural networks are configured to at least one of classify, localize or segment for an occluding object (e.g. a facemask or other objects such as described herein).

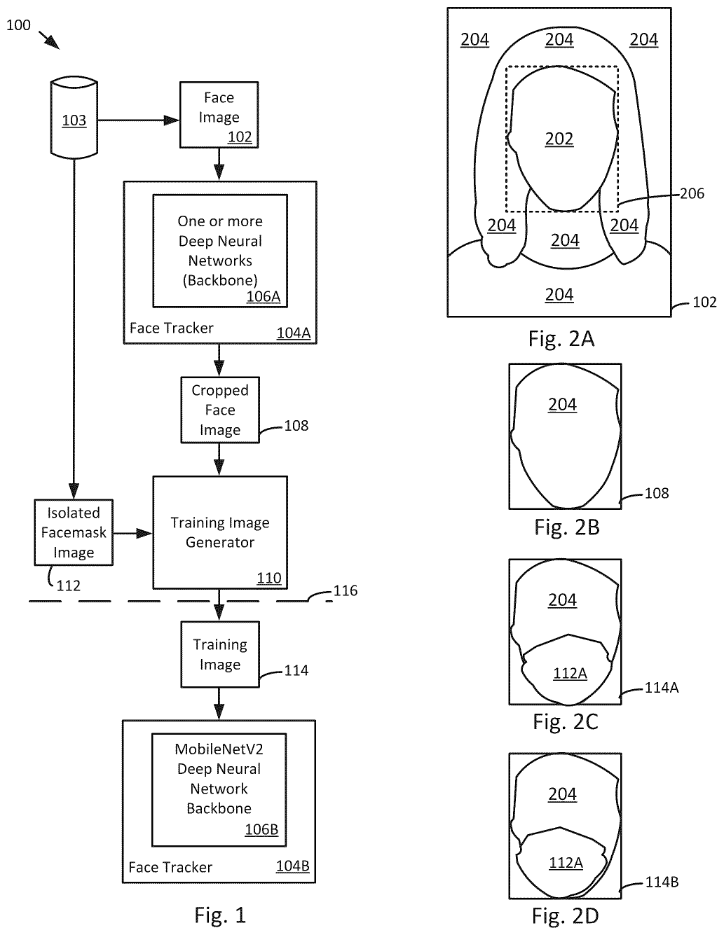

FIG. 1 is a training pipeline 100 according to an embodiment for defining a new deep neural network, where the pipeline 100 includes components to generate training images for training the new deep neural network. In an embodiment, an image including a face (e.g., a face image) 102 is provided, such as from a data store 103, to a face tracker 104A including one or more deep neural networks 106A (each may have a MobileNetV2 deep neural network backbone). Data store 103 can comprise a database or other storage configuration that stores a plurality of different face images for use to train and/or test deep neural networks, for example. Data store 103 can comprise an open data stores available to the public, a closed, proprietary data store or both open and closed data stores.

Face tracker 104A is adapted to track (i.e. localize) classes of objects related to a face, including a face object itself. Output from such a face tracker 104 comprises a bounding box or mask or other structure to derive a cropped face image 108. In cropped face image 108, for example, any background in the face image 102 is minimized. FIG. 2A shows representative face image 102 including a face 202 and background 204. Background may comprise other portions of the subject as well as non-subject portions. A bounding box 206 shown as a dotted line box shows coordinates for defining a cropped image (e.g. 108) including face 202 and minimized background content (some of background 204). FIG. 2B shows a representative cropped image 108.

A training image generator 110 receives cropped face images, such as cropped image 108, and, in accordance with its configuration, generates training images, such as image 114. Training image generator 110, in an embodiment, generates a plurality of training images for each cropped face image it receives. Though not shown, the training images, in an embodiment, are stored to data store 103 such as for later use. In an embodiment, training images are provided for training a deep neural network as further described. Though described as training images, such can comprise testing images in an embodiment.

In an embodiment, training image generator 110 generates training images such as by rendering an effect to at least some of the cropped face images it receives. In an embodiment, the effect is the application of a facemask such as by applying an isolated facemask image 112 (e.g. from data store 103) through a rendering operation. Data store 103 can store a plurality of isolated facemask images. Isolated facemask images, such as image 112, may comprise a portable network graphic (e.g., “.png”) image of a facemask or other usable image format, where the background is transparent. That is, when the facemask is applied over a cropped face image, only the facemask occludes the portion of the cropped image over which it is rendered and the transparent background of the facemask image permits the other portion of the cropped face image to remain visible.

In an embodiment, training image generator 110 operates to: use predicted/labeled points coordinates to add the facemask image onto the cropped face images to generate synthetic data; resize the facemask image prior to application to the cropped face; apply augmentations such as rotation and translation to the mask in at least some of the generated training images to ensure diversity of training data; and generate some training images without masks, for example such that a target percentage of images include masks, for example, 55% of such training images includes masks.

In an embodiment, face tracker 104A outputs facial feature localization data, for example, face points for a face contour. An example is shown in FIG. 2E described further herein. The face points and/or the face's bounding box can be useful to resize the facemask image for the detected face.

In an embodiment, the training image generator defines a plurality of training images from a single cropped face image, where the plurality of training images comprise any one or more of a cropped face image with no facemask added, a plurality of cropped face images each with a different facemask added and/or each with a facemask added in a different manner (e.g. after rotation or translation of the facemask).

FIG. 2C shows a training image 114A comprising a mask image 112A applied to the cropped image of FIG. 2B. FIG. 2D shows a training image 114B comprising a mask image 112A after rotation (e.g. flipped horizontally) and translation. FIG. 2B can also define a training image where no facemask is included in the image.

FIG. 2E shows an example of output 200 from face tracker 104A comprising a cropped face image 202 and groups 204 of face points such as face contour face points 204A, eyebrow face points 204B, and nose face points 204C, etc. The depiction is of an annotated cropped face image 202 with the groups of the face points for purposes of illustration. The face tracker output need not comprise an annotated image and the output can be separate data. The face points in an individual group are numbered (e.g. 0, 1, 2, . . . ) and assist with defining the contour of the detected object. The face tracker assigns each point so that it is placed at consistent locations relative to the contour of the object it is denoting. For example, a particular point might always be at a right corner of the mouth. In an example, the face points are X, Y pixel coordinates, relative to the cropped face image 202 and are associated with respective detected objects from (e.g. one of) the networks 106B of tracker 104A.

Components above dotted line 116 such as face tracker 104A and training image generator 110 are useful to define training images including facemask training images and non-facemask training images from faces as localized.

Training images, such as image 114, are applied to train a deep neural network such as a component of face tracker 104B with one or more deep neural networks 106B (each may have a MobileNetV2 backbone as in 106A). The components 104B and 106B are similar to components 104A and 106A but include applicable configuration for classifying a facemask object in face images. The components 104B and 106B are also configured in an applicable training configuration, for example, as described in the aforementioned publication “MobileNetV2: Inverted Residuals and Linear Bottlenecks”. The deep neural network to be trained for facemask classification can be similarly structure to a deep neural network component of face tracker 104A that classifies (detects) other objects. In an embodiment, the deep neural network for facemask detection need not localize the facemask. In an embodiment, the deep neural network for facemask detection does localize and/or segment the facemask and is thus configured with appropriate structures for training and to produce output as is applicable. That is, the deep neural network may be configured for training to segment and to produce a mask.

Following training, the resulting face tracker 104B with its one or more deep neural networks 106B, as trained, is tested such as by using real images of faces with facemasks. Following testing and training cycles, as may be necessary, the resulting face tracker 104B with its one or more deep neural networks 106B such as may be configured from a real-time or live application use (not a training configuration) is useful to classify face images to identify whether a mask is present or not and/or to localize/segment the facemask. Such may also segment. Preferably, the resulting face tracker 104B with its one or more deep neural networks 106B also classifies and localizes for other face features. In an embodiment, the resulting face tracker 104B with its one or more deep neural networks 106B provides an engine for localizing face features such as for use in an application providing a VTO experience, described further herein below.

Though the embodiments of FIG. 1 are described with reference to one or more networks 106A each having a MobileNetV2 deep neural network backbone, other neural network backbones defined for image localization tasks can form the backbone of the face tracker and be similarly adapted such as through training with synthetic images to detect presence of facemasks (e.g. classify, localize and/or segment for an occluding object).

Though described with reference to detecting a facemask that occludes at least a portion of a face, the methods, apparatus and techniques herein can be adapted such as for defining synthetic data and for training an occluded face detecting network to detect other types of face occlusion where at least part of the face is occluded by another object. For example, synthetic data generation and training may be performed for occlusion by facemasks, occlusion by sun glasses/dark glasses or other occluding eye glasses that occlude a portion of the face, occlusion by hair, occlusion by a scarf, occlusion by a hat, occlusion by a hand/finger(s), occlusion by smartphone (e.g. such as when a mirror taken selfie has a portion of the smartphone covering the (reflected) face in the image), etc.

For greater diversity of training data, it may be preferred to include a diversity of object examples that are applied to the faces—e.g. different examples of types of eye occluding glasses, hats, hands, (numbers of) finger(s), smartphones, etc. In an embodiment, the occluded face detecting network is configured to detect more than one class of occluding object and is trained with training images include occluding objects for each class. Such an occluded face detecting may also be configured and train to localize such objects, including segmenting.

FIG. 3 is a flowchart of operations 300 such as for a computer implemented method. The method can comprise executing by one or more processors the steps of shown in FIG. 3, for example. In an Embodiment 1: the method comprises Step 302 that shows localizing a face in a face input image using a face tracker comprising at least one deep neural network (DNN) trained to localize facial features; and Step 304 that shows producing a training image comprising the face as localized, the training image comprising either an occluded training image where an occluding object is rendered to the face or a non-occluded training image showing a face without the occluding object, the training image produced for occluded face DNN training. In an Embodiment 2: Embodiment 1 can comprise operations such as at step 306 that show training an occluded face detecting DNN with the training image. Training may include training for classification, localization and/or segmentation for the occluding object.

In an Embodiment 3: The occluding object in Embodiment 1 or Embodiment 2 covers at least a portion of the face and comprises any one of a facemask, occluding eye glasses, a hat, a scarf, a hand or fingers, hair, a smartphone, or a portion of any thereof.

In an Embodiment 4: for any of the Embodiments 1 to 3, the occluded face detecting DNN comprises a DNN pre-trained to classify and localize facial features such that, when trained the occluded face detecting DNN detects the presence of at least one face occluding object and classifies and localizes facial features.

In an Embodiment 5: for any of the Embodiments 1 to 4, steps 302 and 304 can be repeated (not shown) with a plurality of face input images of different faces to produce a plurality of training images for occluded face DNN training.

In an Embodiment 6: for any of the Embodiments 1 to 5, producing the training image randomly produces the occluded training image, instead of the non-occluded training image, in accordance with a probability chosen to maximize occluded face DNN training. In an Embodiment 7: for the Embodiment 6, the probability to produce the occluded training image, instead of the non-occluded training image, is a 55% chance.

In an Embodiment 8: for any of the Embodiments 1 to 7, the method comprises (for example between steps 203 and 304 but not shown) cropping the face from the face input image responsive to the localizing and producing the training image using the face as cropped.

In an Embodiment 9: for any of the Embodiments 1 to 8, the occluding object for rendering comprises an isolated occluding object image with a transparent background. In an Embodiment 10: for Embodiment 9 the method comprises, prior to rendering the occluding object to the face as localized, performing one or more of: resizing the occluding object to the face as localized; and augmenting the occluding object to maximize facemask DNN training.

It will be understood that corresponding system embodiments are disclosed for each of Embodiments 1 to 10, for example where the system comprises respective components having computation circuitry configured to perform the operations of the computer implemented method embodiments.

FIG. 1, by way of example, illustrates a system such as one or more processors and/or computational circuitry providing components that can execute any of the method embodiments 1 to 10. For example there is provided a system comprising: a face tracker engine comprising a deep neural network (DNN) to localize a face in a face input image; and a training image generator to produce a training image comprising the face as localized, the training image comprising either an occluded face training image where an occluding object is rendered to the face or a non-occluded training image showing the face without the occluding object, the training image produced for occluded face DNN training.

### VTO Application

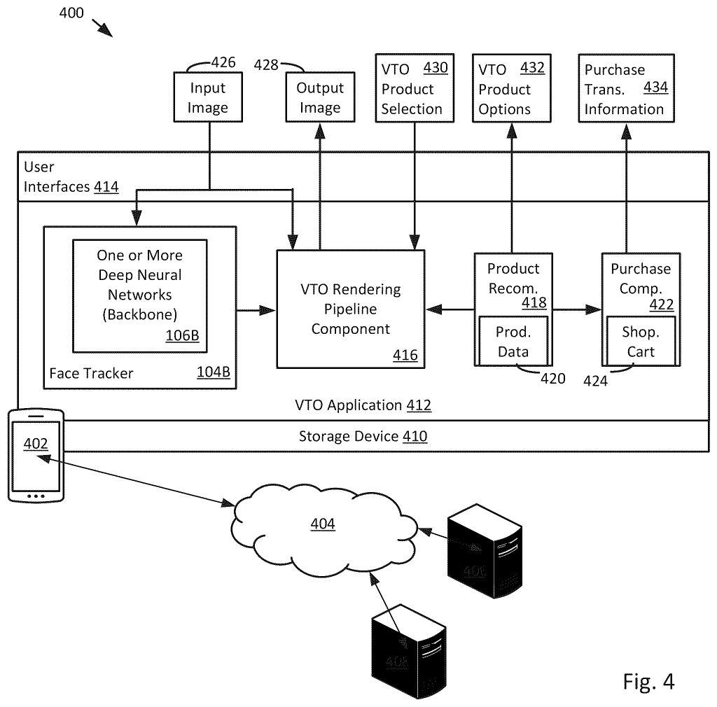

FIG. 4 is an illustration of a computing environment 400, in accordance with an embodiment, such as for practicing one or more method aspects. Computing environment 400 shows a user computing device 402, such as a smartphone, a communications network 404, a server 406 and a server 408. Communications network 404 comprises wired and/or wireless networks, which may be public or private and may include, for example the internet. Server 406 comprises a server computing device such as for providing a website. Server 408 comprises a server computing device such as for providing e-commerce transaction services. Though shown separately, the servers 406 and 408 can comprise one server device. Computing environment is simplified. For example, not shown are payment transaction gateways and other components such as for completing an e-commerce transaction.

Computing device 402 comprise a storage device 410 (e.g., a non-transient device such as a memory and/or solid state drive, etc.) for storing instructions that, when executed by a processor (not shown), cause the computing device 402 to perform operations such as a computer implemented method. Storage device 410 stores a virtual try on application 412 comprising components such as software modules providing, a user interface 414, face tracker 104B with one or more deep neural networks 106B as trained in accordance with FIG. 1, a VTO rendering pipeline component 416, a product recommendation component 418 with product data 420, and a purchasing component 422 with shopping cart 424 (e.g. purchase data).

In an embodiment, VTO application is a web-based application such as is obtained from server 406. Though not shown, user device 402 may store a web-browser for execution of web-based VTO application 412. In an embodiment, VTO application is a native application in accordance with an operating system (also not shown) and software development requirements that may be imposed by a hardware manufacturer, for example, of the user device 402. The native application can be configured for web-based communication or similar communications to servers 406 and 408, as is known.

FIG. 4 shows various input and output data or information associated with a use of VTO application 412, for example. Such includes an input image 426 of the user to be processed for a VTO experience, an output image 428 to which product effects are simulated providing a VTO experience, a VTO product selection 430 comprising user input selecting one or more product effects to be simulated, VTO products options 432 comprising options for products to be virtually tried on, for example for selection by a user of device 402, and purchase transaction information 434 comprising purchase information provided to and/or received from a user to purchase a product.

In an embodiment, via one or more of user interfaces 414, VTO product options 432 are presented for selection to virtually try on by simulating effects on an input image 426. In an embodiment the VTO product options 432 are derived from or associated to product data 420. In an embodiment, the product data can be obtained from server 406 and provided by the product recommendation component 418. Though not shown, user or other input may be received for use to determine product recommendations. The user may be prompted, such as via one of interfaces 414 to provide input for determining product recommendations. In an embodiment, the product recommendation component 418 communicates with server 406. Server 406, in an embodiment, determines the recommendation based on input received via component 418 and provides product data accordingly. User interface 414 can present the VTO product choices, for example, updating the display of same responsive to the data received as the user browses or otherwise interacts with the user interface.

In an embodiment, the one or more user interfaces provide instructions and controls to obtain the input image 426, and VTO product selection input 430 such as an identification of one or more recommended VTO products to try on. In an embodiment, the input image 426 is a user's face image, which can be a still image or a frame from a video. In an embodiment, the input image 426 can be received from a camera (not shown) of device 402 or from a stored image (not shown). The input image 426 is provided to face tracker 104B such as for processing to detect objects in the face image using one or more deep neural networks 106B as trained. In an example, the network classifies, localizes or segments for a facemask (or other occluding object) in the image. For example classification for facemask presence is useful to output a request (e.g. an instruction to a user such as via user interfaces 414), to lower or remove a facemask. Such is applicable to any occluding object for which the face tracker engine is trained.

In an embodiment, output (not shown) from the face tracker 104B, such as classification results, localization results or segmentation results for one or more detected objects, is provided to VTO rendering pipeline component 416. In an example, the output may comprise a bounding box and, as shown in FIG. 2E, face points for detected objects. The input image 426 is also provided (e.g. made available) to component 416. The VTO product selection 430 is also provided to component 416 for determining which effects are to be rendered. In an embodiment related to makeup simulation, one or more effects can be indicated such as for any one or more of the product categories comprising: lip, eye shadow, eyeliner, blush, etc.

VTO rendering pipeline component 416, in an embodiment, determines whether to render one or more product effects to the input image 426 to simulate a try on. For example, responsive to facemask classification output, VTO rendering pipeline component 416 can determine not to render a product effect, for example, because a mask is detected. When a facemask is detected, for example, VTO rendering pipeline component 416 can trigger the user interface 414 to ask the user to remove the facemask. A new image can be received and processed by face tracker 104B. In an embodiment, images are continuously received as a component of a live stream (e.g. a selfie video).

If VTO rendering pipeline component 416 determines to render the one or more product effects, in an embodiment VTO rendering pipeline component 416 renders effects on the input image 426 such as by drawing (rendering) effects in layers, one layer for each product effect, to produce output image 428. Portions of the operations of VTO rendering pipeline component 416 (e.g. such as for drawing the layers) can be performed by a graphics processing unit, in an embodiment. The rendering is in accordance with product data 420 as selected by VTO product selection 430 and is responsive to the location of detected objects. For example, a VTO product selection of a lipstick, lip gloss or other lip related product invokes the application of an effect to one or more detected mouth or lip-related objects at respective locations. Similarly a brow related product selection invokes the application of a selected product effect to the detected eye brow objects. Typically, for symmetrical looks, the same brow effects are applied to each brow, the same lip effect to each lip or the same eye effect to each eye region, but this need not be the case. In an example, the rendering is applied to a region that is relative to the detected objects, such as adjacent one or more such detected objects. Some VTO product selections comprise a selection of more than one product such as coordinated products for brows and eyes or other combinations of detected objects. VTO rendering pipeline component 416 can render each effect, for example, one at a time until all effects are applied. The order of application can be defined by rules or in the selection of products e.g. lipstick before a top gloss.

In an embodiment where an occluding object is detected and the location is determined, for example, as represented in a segmentation mask, the rendering can be responsive to such a segmentation mask. Rendering of an effect can be applied to portions of the face that are not occluded. A segmentation mask can indicate the pixels of the face that are available to (e.g. may) receive an effect such as a makeup effect and those pixels that are not available to receive an effect.

User interfaces 414 provide the output image 428. Output image 428, in an embodiment, is presented as a portion of a live stream of successive output images (each an example 428) such as where a selfie video is augmented to present an augmented reality experience. In an embodiment, output image 428 is presented along with the input image 426, such as in a side by side display for comparison. In an embodiment, output image 428 can be saved (not shown) such as to storage device 410 and/or shared (not shown) with another computing device.

In an embodiment, (not shown) the input images comprise input images of a video conferencing session and the output images comprise a video that is shared with another participant (or more than one) of a video conferencing session. In an embodiment the VTO application is a component or plug in of a video conferencing application (not shown) permitting the user of device 402 to wear makeup during a video conference with one or more other conference participants.

In an embodiment, as further described herein below, VTO rendering pipeline component 416 is configured to apply object stabilization to stabilize respective locations of detected objects between, for example, successive frames of a video.

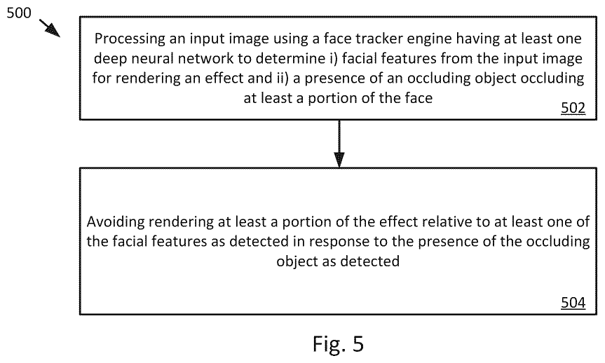

FIG. 5 is a flowchart of operations 500 such as for a computer-implemented method. The method can comprise executing by one or more processors the steps of shown in FIG. 5, for example. In an Embodiment 11: the method comprises: Step 502 that shows processing an input image using a face tracker engine having at least one deep neural network to determine i) facial features from the input image for rendering an effect and ii) a presence of an occluding object occluding at least a portion of the face; and Step 504 that shows avoiding rendering at least a portion of the effect relative to at least one of the facial features as detected in response to the presence of the occluding object as detected.

Embodiment 12: In Embodiment 11, the method comprises at least one of: i) providing a recommendation interface for recommending one or more makeup products to virtually try on, each of the products associated with one or more effects to be rendered in association with one or more facial features; or ii) providing a purchase transaction interface to facilitate the purchase of makeup products.

Embodiment 13: In Embodiment 11 or Embodiment 12, the processing of the input image by the face tracker engine provides a segmentation of the occluding object and the step of avoiding rendering at least a portion of the effect is responsive to the segmentation such that at least a portion of the effect occluded by the occluding object is unrendered. Embodiment 14: In Embodiment 13, the method comprises providing an instruction via a user interface to remove the occluding object to facilitate a full rendering of the effect.

Embodiment 15: In any of Embodiments 11 to 14, the method comprises (e.g. after the step of avoiding rendering for example by not rendering any effect) providing an instruction via a user interface to remove the occluding object to facilitate the rendering.

Embodiment 16: In any of Embodiments 11 to 15 the method comprises, receiving and processing an additional image using the face tracker engine for facial feature detection and occluding object detection; and rendering the effect after the presence of the occluding object is no longer detected.

Embodiment 17: In any of Embodiments 11 to 16 the effect is a makeup effect and the method is performed in the context of computer operations providing a virtual try on experience.

It will be understood that corresponding system embodiments are disclosed for each of Embodiments 11 to 17, for example where the system comprises respective components having computation circuitry configured to perform the operations of the computer implemented method embodiments.

### Object Stabilization

Object localization using deep neural network processing can result in jitter or other instability between images. That is, the predicted location of an object in a first image by a DNN can be perceptibly different from the predicted location of the same object in a second image by the DNN. This is particularly perceptible when the first and second images are two successive frames of a video and an effect is applied in response to the predicted locations. The effect moves with the jitter. Tracking the object between successive frames and rendering an effect over the input frames can cause the effect to jitter or move in a way that does not appear to match the underlying input frames when displayed together.

In an embodiment stabilization is applied to the localization of a detected object produced by a DNN processing a current frame. In an embodiment, such as for providing a VTO experience from a “live” stream of video (e.g. a selfie video) or video conferencing or chat video, each frame (e.g. as successive images) of the video is processed to detect and localize the objects, and to render an effect in accordance with a product or service to be virtually tried on. The effect is applied at one or more locations or regions relative to at least one of the detected objects.

In an embodiment, prior to rendering, the locations of the detected objects (e.g. at least the ones associated with the effects) are stabilized to smooth tracking. These stabilized locations are used for rendering the effect. The effect can be applied at a stabilized location for a detected object (e.g. a stabilized brow location or lip location, etc.), or a region adjacent to one or more detect objects such as an eyelid region adjacent to a stabilized location of a detected eye. In some images, such as where a facemask is worn, not all objects are located.

In an embodiment, stabilization is performed using an optical flow technique (e.g. “optical flow tracking”) that predicts a location of an object in a current frame. In an embodiment, locations of face points, such as are output from a face tracker as previously described, can be stabilized.

Stabilization processing is resource intensive. According to an embodiment, detected objects are grouped by importance to the task: i.e. by importance to the VTO experience. In an embodiment, locations of detected objects related to the mouth and eyes are stabilized using a blending of a tracker prediction from a current frame and an optical flow prediction for the current frame that is responsive to stabilized locations in a previous frame; and locations of detected objects related to the brows, nose and face contour are stabilized using an exponential moving average filter responsive to a net velocity of an object's face points over previous n frames.

Below is an embodiment of stabilizing operations Stab-1 to Stab 5b, which operations comprise:

Stab-1. Obtain a face points prediction from a face tracker engine (e.g. 104A or 104B) as trackerPₜ. The tracker prediction trackerPₜ relates to a current frame at time t of a video. The previous frame is at previous time t−1. The tracker prediction includes locations of the variously detected objects e.g., a set of face points per detected object, such as per FIG. 2E. Stabilization seeks to produce stabilized face points pₜ per detected object for a current frame. Stabilized face points (stabilized location) per detected object for a previous frame produced by the stabilizing operations are denoted as pₜ₋₁.

Stab-2. In an embodiment, the face points received from the face tracker, such as those representing an object contour as shown in FIG. 2E, are grouped by object as left eye, right eye, left brow, right brow, nose, outer mouth, inner mouth, and face contour groups of points (e.g. a subset of trackerPₜ for each object). In an embodiment, the objects are assigned an importance rating, which, in an embodiment is one of two ratings (e.g. higher/lower importance). In an embodiment, stabilization for an object is performed in response to the importance rating using one set of operations for the higher importance objects and another set of operations for the lower importance objects. In an embodiment, the stabilization operations performed for the objects of higher importance are more accurate but also more resource and/or processing intensive than the operations performed for objects of lower importance. Thus the objects are assigned an importance rating that balances accuracy with device performance criteria (e.g. processing time/memory usage, etc.) In an embodiment, the objects left eye, right eye, outer mouth, and inner mouth are assigned the higher importance rating and the objects left brow, right brow, nose, and face contour are assigned the lower importance rating. In an embodiment, eyes and lips are prioritized, for example, because many effects relate to eyes and lips.

Stab-3. For the higher importance objects: Apply an optical flow function to pₜ₋₁ for only the higher importance objects to get optFlowPₜ. The function optFlow calculates an optical flow (e.g., image velocity) for a sparse feature set using the iterative Lucas-Kanade method with pyramids (previous frame pyramid and current frame pyramid). (See Bouguet, J.-Y. (1999). Pyramidal implementation of the Lucas Kanade feature tracker. At time of filing, available at semanticscholar.org). It will be understood that optFlowPₜ for a particular object represents predicted face points for the object for the current frame responsive to the stabilized face points (locations) pₜ₋₁ produced for the object in the previous frame. In an embodiment implemented with an optical flow function by OpenCV, the points for all of the objects of higher importance are provided together, for example, rather than processing each object separately.

Stab-4. For the higher importance objects: Blend using a blendingfactor and correct if distance between tracker location and optflow location are above a threshold: At regular intervals, set blendingFactor=0.4 (a startValue). The regular intervals can be based on time or a frame count (e.g. a rough time equivalent) e.g. every 1.3 seconds or every 40 frames. Time may be preferred for consistency as frame count to approximate time relies on processing speed. On every frame, run blendingFactor*=0.080 (a decayValue). The blending factor is used to control the blend between trackerPₜ and optFlowPₜ and is reset to the startValue (e.g. 0.4) to avoid having optFlowPₜ drift too far away from trackerPₜ. Over time the optflow points and face tracker points may drift apart. If blending makes an abrupt change, then blending could result in a jarring result.

For each blending group of points (left eye, right eye, inner mouth, outer mouth):

Stab-4.a. Blend based on blendingFactor:

$$\\ {p}_{t} = blendingFactor * {trackerP}_{t} + ( 1 - blendingFactor ) * {optFlowP}_{t}$$

Stab-4.b. Blend based on distance—compare pixel distances between corresponding face points of trackerPₜ and optFlowPₜ. For the mouth object, as an example, compare corner of mouth face point from trackerPₜ to same face point from optFlowPₜ. If trackerPₜ and optFlowPₜ are too far apart, blend towards trackerPₜ:

$$\\ amount = {min ( \frac{‖ {optFlowP}_{t} - {trackerP}_{t} ‖}{distanceBlendingNorm} , 1. )}^{6}$$

$$\\ {p}_{t} = amount * {trackerP}_{t} + ( 1. - amount ) * {p}_{t}$$

where distanceBlendingNorm is a normalization factor for the point distance, and ( )⁶ is used to make small values smaller. For example, distanceBlendingNorm is 5 pixels in an embodiment.

Stab-5. For the lower importance objects: Apply an exponential moving average filter to the points of left brow, right brow, nose, face contour.

Stab-5.a. For each group, the net velocity v is calculated and averaged over the previous n frames. In an embodiment, the velocity calculation uses the tracker points for both the previous frame and current frame trackerPₜ and trackerPₜ₋₁, and doesn't use the stabilized points pₜ₋₁ for the previous frame These stabilize points are eventually used when applying the blending determined using the velocity calculation result. A reason for this is that using the tracker points would allow operations to more quickly pick up changes in the velocity, as opposed to using the stabilized points.

$$\\ velocity = \frac{{\sum }_{i = 1}^{n} {trackerP}_{t} - {trackerP}_{t - 1}}{n}$$

$$\\ v = {velocity}_{group} = \frac{‖ {\sum }_{i ∈ group} {velocity}_{i} ‖}{{n}_{group pts}}$$

Stab-5.b. The updated face points coordinates are calculated using a blending factor α:

$$\\ α = {max ( min ( \frac{1}{transitionSpeedFactor} * v , 1 ) , 0.1 )}^{2}$$

$$\\ {p}_{t} = α * {trackerP}_{t} + ( 1. - α ) * {p}_{t - 1}$$

where transitionSpeedFactor is a constant that controls the impact of v, and is 1.5 by default.

Thus, in relation to blending operations Stab-4.a and Stab-4.b, a form of linear interpolation is performed for each of the eye and mouth groups respectively (i.e. for respective facial features from the more important group of facial features). In particular, the two locations (tracker location and the optflow location (second location)) for a respective face point in the current image are blended according to a blending factor. The blending factor weights the contribution of each of the tracker location and the optflow location to produce a first blended result. A second blending operation producing the current stabilized location and is responsive to distance between the two locations (e.g. a distance between pixel coordinates of respective face points of the tracker location and corresponding respective face points of the second tracker location) and a distance normalization factor to move the first blending result toward the tracker location. Thus the blending factor blends the tracker location and optiflow location initially in favor of the optiflow location—itself based on previous stabilized locations; and applies a correction if the two locations are sufficiently distant, and generates the current stabilized location from the first blended result as moved toward the tracker location.

In an embodiment, the blending factor for the first blending result varies (decays) from a max. amount, for a period (e.g. a series of frames or for a defined time), then the blending factor is reset to the max. amount. As the blending factor decays, the optiflow location is increasingly preferred in the blending. The reset serves to realign the blending should the locations have drifted. For the distance based blending threshold, in an embodiment, the distance normalization factor is 5 pixels.

Thus in relation to operations Stab-5.a and Stab-5.b performed for each of the less important groups (bows, nose and face contour), an exponential moving average filter is applied. In the exponential moving average filter, operations use only the points from the previous and current frame. The previous frame's points implicitly contain information from the older frames due to the iterative application of stabilization across frames. In an alternative approach, not shown, a window of previous location values is determined and averaged. For example, points from the current frame and the previous N frames (for example, N=3), for a total of N+1 frames can be used. The resulting point is calculated as an average of the points across the N+1 frames. The average can be a weighted average, for example having a higher weight on the more recent frames. The weight can further be influenced by the velocity. For example a higher velocity could place an even greater weight on the most recent frame.

However, any method for smoothing time series data could be used as an alternative. Another example could be a Kalman Filter, which tries to estimate the current state by modelling the dynamics of the system (such as predicting the current point using the past velocity) and combining that prediction with the current measurement (the tracker point).

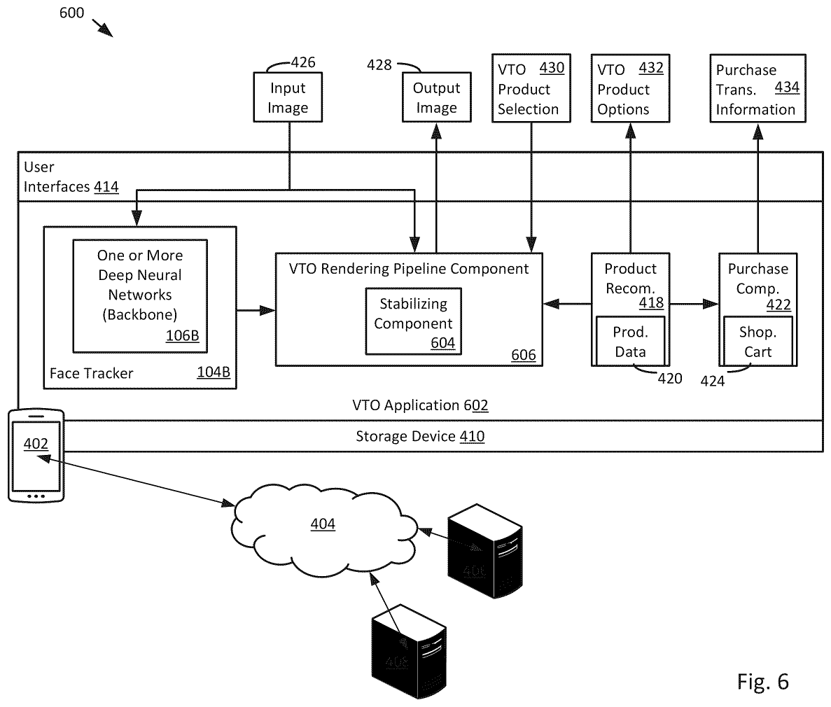

FIG. 6 is an illustration of a computing environment 600, in accordance with an embodiment. Computing environment 600 is similar to environment 400, however VTO application 602 differs from VTO application 412 in that VTO application 602 includes a stabilization component 604. While shown as an included component of VTO rendering pipeline component 606, stabilizing component 604 can be a separate component. VTO rendering pipeline component 606 is similar to component 416 but includes stabilization of detected objection locations for rendering effects relative to the stabilized locations.

In an embodiment, the operations of stabilizing component 604 are configured such as described with reference to operations Stab-1 to Stab-5b herein above.

VTO application 602 comprises face tracker 104B with its one or more deep neural networks 106B that is configured for facemask classification, localization or segmentation, such as to detect facemask (or other occluding object) presence in a face image. In an embodiment, VTO application could comprise a face tracker with one or more deep neural networks that localizes facial features but without detecting facemask (or other occluding object) presence, for example, similar to face tracker 104A.

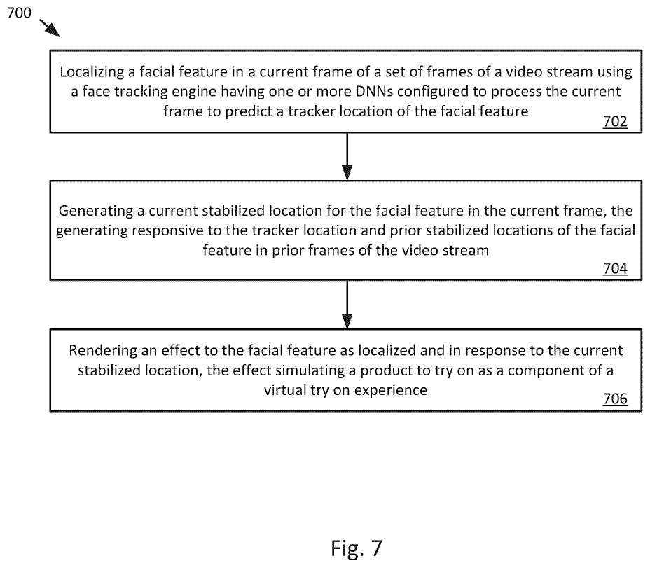

FIG. 7 is a flowchart of operations 700 such as for a computer-implemented method. The method can comprise executing by one or more processors the steps shown in FIG. 7, for example. In an Embodiment 18: the method comprises step 702 localizing a facial feature in a current frame of a set of frames of a video stream using a face tracking engine having one or more DNNs configured to process the current frame to predict a tracker location of the facial feature; step 704 that shows generating a current stabilized location for the facial feature in the current frame, the generating responsive to the tracker location and prior stabilized locations of the facial feature in prior frames of the video stream; and step 706 that shows rendering an effect to the current frame associated with the facial feature responsive to the current stabilized location, the effect simulating a product to try on as a component of a virtual try on experience. Though not shown, operations can include providing the current frame and effect as rendered (e.g. as an output image) for presentation.

Embodiment 19: In Embodiment 18, the method comprises at least one of: i) providing a recommendation interface for recommending one or more makeup products to virtually try on, each of the products associated with one or more effects to be rendered in association with one or more facial features; or ii) providing a purchase transaction interface to facilitate the purchase of makeup products.

Embodiment 20: In Embodiment 18 or 19, the method localizes a plurality of facial features and the plurality of facial features are grouped by an importance rating associated with the virtual try on experience to define a more important group of facial features and a less important group of facial features and wherein respective current stabilized locations for the plurality of facial feature are determined responsive to the importance rating to select between different stabilizing operations to balance accuracy with device performance criteria. Embodiment 21: In Embodiment 20, the plurality of facial features comprise a left eye object, right eye object, and at least one mouth object grouped as more important facial features and left brow object, right brow object, nose object and face contour object grouped as less important facial features.

Embodiment 22: In any of Embodiments 18 to 21, generating the current stabilized location comprises one of: operation (a): blending the tracker location and a second location for the facial feature in the current frame using linear interpolation, the second predicted location responsive to an optical flow determined for the facial feature using the tracker location and a previous stabilized location for the facial feature in an immediately previous frame; or operation (b) applying an averaging to the tracker location and the previous stabilized location of the facial feature, the averaging responsive to an averaged velocity determined from the tracker location and respective prior tracker locations for the facial feature over a set of prior frames.

Embodiment 23: In Embodiment 22: the method localizes a plurality of facial features and the plurality of facial features are grouped by an importance rating associated with the virtual try on experience to define a more important group of facial features and a less important group of facial features; for an individual facial feature from the more important group, the current stabilized location is generated according to operation (a); for an individual facial feature from the less important group, the current stabilized location is generated according to operation (b); and the rendering renders one or more effects associated with at least some of the plurality of facial features using respective current stabilized locations.

Embodiment 24: In Embodiment 21 or 22: operation (a) comprises in respect of a particular facial feature to be stabilized over a set of frames including the current frame and the immediately previous frame: blending respective face points of the tracker location with corresponding respective face points of the second location according to a blending factor that weights the contribution of each of the tracker location and the second location to produce a first blended result; and further blending the first blended result and the respective face points of the tracker location to produce the current stabilized location according to a distance between pixel coordinates of respective face points of the tracker location and corresponding respective face points of the second tracker location, the further blending moving the first blended result toward the tracker location in response to a distance normalization factor.

Embodiment 25: In Embodiment 24 the method comprises initializing the blending factor to a maximum amount, at each frame to be processed, decaying the blending factor, using the blending factor as decayed when blending, and periodically resetting the blending factor to the maximum amount.

Embodiment 26: In any one of the Embodiments 18 to 24, the method further comprises performing occlusion detection by the one or more neural networks for the facial feature; and rendering the effect in response to the occlusion detection. Occlusion detection provides occlusion information to indicate the facial feature is occluded. In an embodiment occlusion information is granular and provides granular information about partial occlusion. For example, a segmentation mask from the one or more neural networks indicates which pixels of the facial feature are included (or not). Occlusion is also described further herein below.

It will be understood that corresponding system embodiments are disclosed for each of Embodiments 18 to 26, for example where the system comprises respective components having computation circuitry configured to perform the operations of the computer implemented method embodiments.

In an implementation, optical flow tracking operations are performed on each frame for the purposes of temporal stabilization of the facial landmarks. Given the image and landmarks for the previous frame and the current frame image, optical flow can predict the location of the landmarks for the current frame. The prediction is combined with the output of the face landmarks model in accordance with stabilization operations.

In addition to computing device and method aspects, a person of ordinary skill will understand that computer program product aspects are disclosed, where instructions are stored in a non-transient storage device (e.g. a memory, CD-ROM, DVD-ROM, disc, etc.) and that, when executed, the instructions cause a computing device to perform any of the method aspects stored herein.

While the computing devices are describe with reference to processors and instructions that, when executed, cause the computing devices to perform operations, it is understood that other types of circuitry than programmable processors can be configured. Hardware components comprising specifically designed circuits can be employed such as but not limited to an application specific integrated circuit (ASIC) or other hardware designed to perform specific functions, which may be more efficient in comparison to a general purpose central processing unit (CPU) programmed using software. Thus, broadly herein an apparatus aspect relates to a system or device having circuitry (sometimes references as computational circuitry) that is configured to perform certain operations described herein, such as, but not limited, to those of a method aspect herein, whether the circuitry is configured via programming or via its hardware design.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A computer implemented method comprising executing by one or more processors the steps of:
localizing a face in a face input image using a face tracker comprising one or more deep neural networks (DNNs) trained to localize facial features; and
producing a training image comprising the face as localized, the training image comprising either an occluded training image where an occluding object is rendered to the face or a non-occluded training image showing the face without the facemask, the training image produced for occluded face DNN training.

2. The method of claim 1, comprising training an occluded face detecting DNN with the training image.

3. The method of claim 2, comprising configuring a face tracker engine with the occluded face detecting DNN as trained such that the face tracker engine classifies and localizes facial features and at least one of classifies or localizes face occluding objects.

4. The method of claim 1, wherein steps a. and b. are repeated with a plurality of face input images of different faces to produce a plurality of training images for occluded face DNN training.

5. The method of claim 1, wherein producing the training image randomly produces the occluded training image, instead of the non-occluded training image, in accordance with a probability chosen to maximize occluded face DNN training.

6. The method of claim 5, wherein the probability to produce the occluded face training image, instead of the non-occluded training image, is a 55% chance.

7. The method of claim 1, comprising cropping the face from the face input image responsive to the localizing and producing the training image using the face as cropped.

8. The method of claim 1, wherein the occluding object for rendering comprises an isolated occluding object image with a transparent background.

9. The method of claim 8, wherein prior to rendering the occluding object to the face as localized, the method comprises performing one or more of:
resizing the occluding object to the face as localized; and
augmenting the occluding object to maximize occluded face DNN training.

10. The method of claim 1, wherein the occluding object covers at least a portion of the face and wherein the occluding object comprises any of a facemask, occluding eye glasses, a hat, a scarf, a hand or one or more fingers, a smartphone, hair, or a portion of any of thereof.

11. A system comprising:
a face tracker engine comprising a deep neural network (DNN) to localize a face in a face input image; and
a training image generator to produce a training image comprising the face as localized, the training image comprising either an occluded training image where an occluding object is rendered to the face or a non-occluded training image showing the face without the occluding object, the training image produced for occluded face DNN training.

12. A computer implemented method comprising executing by one or more processors the steps of:
localizing a facial feature in a current frame of a set of frames of a video stream using a face tracking engine having one or more deep neural networks (DNNs) configured to process the current frame to predict a tracker location of the facial feature;
generating a current stabilized location for the facial feature in the current frame, the generating responsive to the tracker location and prior stabilized locations of the facial feature in prior frames of the video stream; and
rendering an effect to the current frame associated with the facial feature responsive to the current stabilized location, the effect simulating a product to try on as a component of a virtual try on experience.

13. The computer implemented method of claim 12 comprising at least one of: i) providing a recommendation interface for recommending one or more makeup products to virtually try on, each of the products associated with one or more effects to be rendered in association with one or more facial features; or ii) providing a purchase transaction interface to facilitate the purchase of makeup products.

14. The computer implemented method of claim 12, wherein the method localizes a plurality of facial features and the plurality of facial features are grouped by an importance rating associated with the virtual try on experience to define a more important group of facial features and a less important group of facial features and wherein respective current stabilized locations for the plurality of facial feature are determined responsive to the importance rating to select between different stabilizing operations to balance accuracy with device performance criteria.

15. The computer implemented method of claim 14, wherein the plurality of facial features comprise a left eye object, right eye object, and at least one mouth object grouped as more important facial features and left brow object, right brow object, nose object and face contour object grouped as less important facial features.

16. The computer implemented method of claim 12, wherein generating the current stabilized location comprises one of:
operation (a): blending the tracker location and a second location for the facial feature in the current frame using linear interpolation, the second predicted location responsive to an optical flow determined for the facial feature using the tracker location and a previous stabilized location for the facial feature in an immediately previous frame; or
operation (b): applying an averaging to the tracker location and the previous stabilized location of the facial feature, the averaging responsive to an averaged velocity determined from the tracker location and respective prior tracker locations for the facial feature over a set of prior frames.

17. The computer implemented method of claim 16, wherein:
the method localizes a plurality of facial features and the plurality of facial features are grouped by an importance rating associated with the virtual try on experience to define a more important group of facial features and a less important group of facial features;
for an individual facial feature from the more important group, the current stabilized location is generated according to operation (a);
for an individual facial feature from the less important group, the current stabilized location is generated according to operation (b); and
the rendering renders one or more effects associated with at least some of the plurality of facial features using respective current stabilized locations.

18. The computer implemented method of claim 16, wherein, operation (a) comprises in respect of a particular facial feature to be stabilized over a set of frames including the current frame and the immediately previous frame:
blending respective face points of the tracker location with corresponding respective face points of the second location according to a blending factor that weights the contribution of each of the tracker location and the second location to produce a first blended result; and
further blending the first blended result and the respective face points of the tracker location to produce the current stabilized location according to a distance between pixel coordinates of respective face points of the tracker location and corresponding respective face points of the second tracker location, the further blending moving the first blended result toward the tracker location in response to a distance normalization factor.

19. The computer implemented method of claim 18, comprising initializing the blending factor to a maximum amount, at each frame to be processed, decaying the blending factor, using the blending factor as decayed when blending, and periodically resetting the blending factor to the maximum amount.
